(19) United States
(12) Patent Application Publication
(10) Pub. No.: US 2008/0056702 A1
(43) Pub. Date: Mar. 6, 2008

(54) Method of real-time auto focus

(76) Inventors: Tsun-Hou Chou, Taipei City (TW); Shen-Fu Tsai, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/512,363

(22) Filed: Aug. 30, 2006

(51) Int. Cl. G03B 13/00

(52) U.S. Cl. 396/127

(57) ABSTRACT

A method of real-time auto focus includes: (a) judging whether a focus environment is changed by a focus environment judgment unit of a real-time auto focus system; (b) if the focus environment has been changed, figuring out a contrast value by a frame that is captured via a sensor of the real-time auto focus system; (c) judging whether the contrast value is larger than last contrast value by comparing the contrast value with last contrast value; (d) if the contrast value is larger than last contrast value, letting a lens move along one direction, and then if the contrast value is not larger than last contrast value, letting a lens move along the other direction; and (e) repeating the cycle of the step (b)-(d) until the total number of the cycle time reaches the predetermined total cycle time.

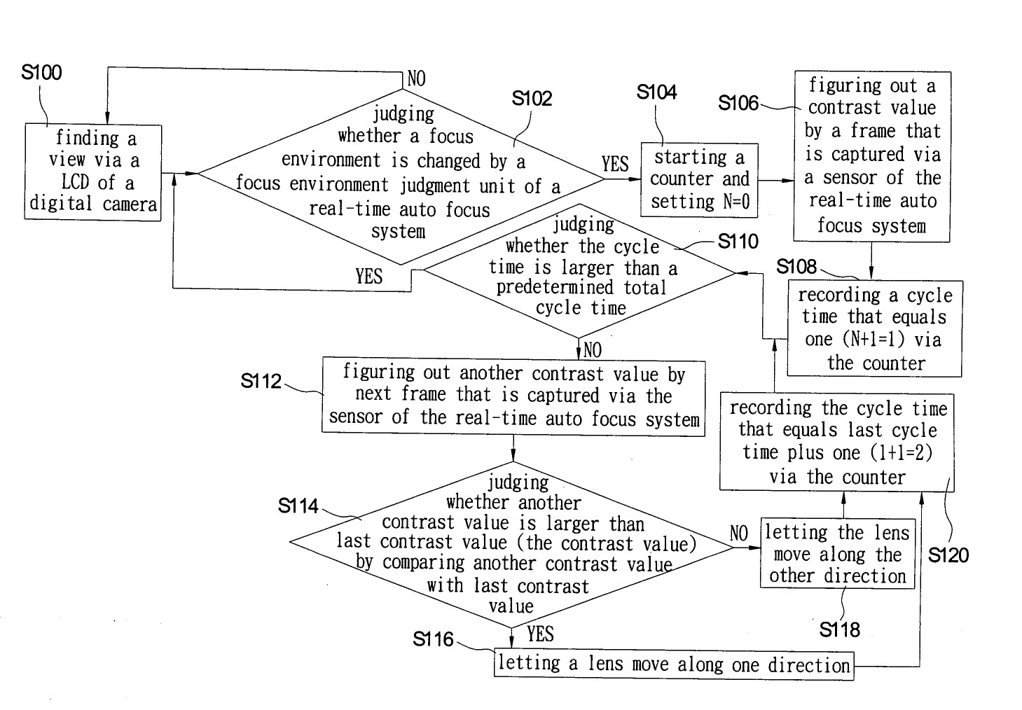

### BACKGROUND OF THE INVENTION

1. Field of The Invention

The present invention relates to a method of real-time auto focus, and particularly relates to a method for showing a most clear frame on a LCD of a digital camera when using the LCD to find a view, via a real-time auto focus system that is operated to control a lens of the digital camera according to the information of an external environment and the calculation of a frame captured via a sensor of the digital camera.

2. Description of the Related Art

There are many methods for people to commemorate an occasion. One common way is by taking pictures, because any occasion such as travel, a celebration, an event or any good time that deserves to be commemorated can be recorded via a camera. Moreover, it is convenient for users to transmit image data from the camera to an electronic device such as a computer for modifying the image data. In addition, the price of a camera has become increasingly cheaper, so the number of people using digital cameras increases day by day.

Moreover, an auto focus system has been commonly utilized in today's digital cameras. The main purpose of the auto focus system is that when taking a picture user does not have to adjust the focal distance of the camera lens. The motor inside the digital camera will adjust the focal length automatically according to the information obtained by the digital camera and via a motor's driving of the digital camera. Thus, the photograph taken is up to standard. Furthermore, most of the digital cameras in the market are equipped with a LCD panel. This facilitates the user when taking a picture. As a result, real-time focusing technology was developed based on this innovative method of shooting.

However, theories often contradict with reality. There are few disadvantages and drawbacks when putting real-time auto focusing system into practice. They are as follows:

1. Real-time auto focusing system is normally set to re-auto focus every 3 seconds regardless of the shooting environments. As a result, there will be unnecessary battery consumption.

2. There are steps sets for the camera lens to auto focus. When auto focusing, camera lens has to do a complete loop of these steps to acquire a best focal point. Consequently, it is a little slow in time and does not really fit the function of “real-time focusing”.

3. The accuracy of auto focusing depends on the number of steps taken for the camera lens to focus. The steps set for auto focusing in the camera are normally a few due to the consideration for focusing speed and time. Thus, other minor tuning (fine-tuning) steps of the camera lens for focusing are neglected. This will affect the accuracy of auto focus.

### SUMMARY OF THE INVENTION

The present invention provides a method of real-time auto focus. The method can show a most clear frame on a LCD of a digital camera when using the LCD to find a view, via a real-time auto focus system for increasing the success rate of taking a picture.

Moreover, there are some advantages in the present invention, as follows:

1. A lens of the digital camera can be moved to correct direction according to a value that is figured out from a frame that is captured via a sensor of the real-time auto focus system. Hence, the focus speed would reach a certain level.

2. The focus speed and the focus accuracy are increased at the same time by every fine-tuning step for lens.

3. The present invention can judge whether a focus environment is changed by a focus environment judgment unit that comprises an auto exposure unit and an auto white balance unit, or any judgment device for judging whether the focus environment is changed or not.

A first aspect of the present invention is a method of real-time auto focus, comprising: (a) judging whether a focus environment is changed by a focus environment judgment unit of a real-time auto focus system; (b) if the focus environment has been changed, starting a counter and setting N=0; (c) figuring out a contrast value by a frame that is captured via a sensor of the real-time auto focus system; and (d) recording a cycle time that equals one (N+1=1) via the counter.

Moreover, (e) judging whether the cycle time is larger than a predetermined total cycle time; (f) if the cycle time is not larger than the predetermined total cycle time, figuring out another contrast value by next frame that is captured via the sensor of the real-time auto focus system again; (g) judging whether another contrast value is larger than last contrast value by comparing another contrast value with last contrast value; (h) if another contrast value is larger than last contrast value, letting a lens move along one direction; and then if another contrast value is not larger than last contrast value, letting a lens move along the other direction; (i) recording the cycle time that equals last cycle time plus one (1+1=2) via the counter; and, (e) repeating the cycle of the step (e)˜(i) until the total number of the cycle time reaches the predetermined total cycle time.

A second aspect of the present invention is a method of real-time auto focus, comprising: (a) judging whether a focus environment is changed by a focus environment judgment unit of a real-time auto focus system; (b) if the focus environment has been changed, figuring out a contrast value by a frame that is captured via a sensor of the real-time auto focus system; (c) judging whether the contrast value is larger than last contrast value by comparing the contrast value with last contrast value; (d) if the contrast value is larger than last contrast value, letting a lens move along one direction, and then if the contrast value is not larger than last contrast value, letting a lens move along the other direction; and (e) repeating the cycle of the step (b)˜(d) until the total number of the cycle time reaches the predetermined total cycle time.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

The FIGURE is a flow chart of a method of real-time auto focus according to the present invention.

### DETAILED DESCRIPTION OF PREFERRED BEST MOLDS

Referring to the FIGURE, the present invention provides a method of real-time auto focus. The steps of the method include: firstly, finding a view via a LCD of a digital camera (S100), and then judging whether a focus environment is changed by a focus environment judgment unit of a real-time auto focus system (S102). Moreover, the focus environment judgment unit comprises an auto exposure unit and an auto white balance unit, or any judgment device for judging whether the focus environment is changed or not. In the step of S102, if the focus environment does not be changed, performing the step of S100; if the focus environment has been changed, starting a counter and setting N=0 (S104).

Moreover, the method further includes: figuring out a contrast value by a frame that is captured via a sensor of the real-time auto focus system (S106); recording a cycle time that equals one (N+1=1) via the counter (S108); and then judging whether the cycle time is larger than a predetermined total cycle time (S110). If the cycle time is larger than the predetermined total cycle time, returning back to the step of S102. If the cycle time is not larger than the predetermined total cycle time, figuring out another contrast value by next frame that is captured via the sensor of the real-time auto focus system (S112).

Furthermore, the method further includes: judging whether another contrast value is larger than last contrast value (the contrast value) by comparing another contrast value with last contrast value (S114). If another contrast value is larger than last contrast value, letting a lens move along one direction (S116). If another contrast value is not larger than last contrast value, letting the lens move along the other direction (S118). In addition, the lens is moved via a motor. Next, the method includes: recording the cycle time that equals last cycle time plus one (1+1=2) via the counter (S120). For example: first cycle time equals one (N+1=1, when N=0), second cycle time equals two (1+1=2), third cycle time equals three (2+1=3), and so on. Moreover, the method further includes: repeating the cycle of the step S110˜S120 until the total number of the cycle time reaches the predetermined total cycle time. In other words, when the cycle of the step S110˜S120 finishes, the cycles increases one until the cycle time is larger than the predetermined total cycle time.

In conclusion, when a user want to find a view via the LCD of the digital camera, the focus environment judgment unit that comprises AE and AWB, or any judgment device can be used to judge whether a focus environment is changed or not (judge whether the user moves the digital camera or not). If the user moves the digital camera, it means a focus object has been changed. At this time, the method performs first cycle time. For example, the total cycle time is twelve. After moving the digital camera, a contrast value is figured out by a frame that is captured via the sensor of the real-time auto focus system. Next, compare the contrast value with last contrast value, and a comparing value is figured out by judging whether the contrast value is close to last contrast value. If the contrast value is close to last contrast value, it means that the frame shown on the LCD is clearer. Hence, the lens needs to be forwardly moved continuously along the same direction. If the contrast value is not close to last contrast value, it means that the lens needs to be returned back to move along an opposite direction. The cycle needs to be performed until the cycle time finishes (12 times).

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of real-time auto focus, comprising:
(a) judging whether a focus environment is changed by a focus environment judgment unit of a real-time auto focus system;
(b) if the focus environment has been changed, starting a counter and setting N=0;
(c) figuring out a contrast value by a frame that is captured via a sensor of the real-time auto focus system;
(d) recording a cycle time that equals one (N+1=1) via the counter;
(e) judging whether the cycle time is larger than a predetermined total cycle time;
(f) if the cycle time is not larger than the predetermined total cycle time, figuring out another contrast value by next frame that is captured via the sensor of the real-time auto focus system again;
(g) judging whether another contrast value is larger than last contrast value by comparing another contrast value with last contrast value;
(h) if another contrast value is larger than last contrast value, letting a lens move along one direction; and then if another contrast value is not larger than last contrast value, letting a lens move along the other direction;
(i) recording the cycle time that equals last cycle time plus one (1+1=2) via the counter; and
(e) repeating the cycle of the step (e)˜(i) until the total number of the cycle time reaches the predetermined total cycle time.

2. The method as claimed in claim 1, wherein the lens is moved via a motor.

3. The method as claimed in claim 1, wherein the counter is used to calculate the total number of the cycle time.

4. The method as claimed in claim 1, wherein the focus environment judgment unit comprises an auto exposure unit and an auto white balance unit.

5. A method of real-time auto focus, comprising:
(a) judging whether a focus environment is changed by a focus environment judgment unit of a real-time auto focus system;
(b) if the focus environment has been changed, figuring out a contrast value by a frame that is captured via a sensor of the real-time auto focus system;
(c) judging whether the contrast value is larger than last contrast value by comparing the contrast value with last contrast value;
(d) if the contrast value is larger than last contrast value, letting a lens move along one direction, and then if the contrast value is not larger than last contrast value, letting a lens move along the other direction; and
(e) repeating the cycle of the step (b)˜(d) until the total number of the cycle time reaches the predetermined total cycle time.

6. The method as claimed in claim 5, wherein the lens is moved via a motor.

7. The method as claimed in claim 5, further comprising a counter that is used to calculate the total number of the cycle time.

8. The method as claimed in claim 5, wherein the focus environment judgment unit comprises an auto exposure unit and an auto white balance unit.
